(19) United States
(12) Patent Application Publication
(10) Pub. No.: US 2002/0130512 A1
(43) Pub. Date: Sep. 19, 2002

(54) Viewable envelope

(76) Inventor: Patrick Garrett, Studio City, CA (US)

Correspondence Address: CHARLES R. SUTTON, 14507 SYLVAN ST., STE. 208, VAN NUYS, CA, 91411, US

(21) Appl. No.: 10/078,289

(22) Filed: Feb. 16, 2002

Related U.S. Application Data
(60) Provisional application No. 60/269,475, filed on Feb. 16, 2001.

(51) Int. Cl. B42D 15/00

(52) U.S. Cl. 283/116

(57) ABSTRACT

A window envelope suitably sized to contain an eight inch by ten inch photo without the photo being folded. While most of the surface of the envelope is opaque, allowing the sending of private correspondence, the envelope contains a window of suitable size and shape so that the photo can be seen, and necessarily is seen, by anyone who looks at the surface of the envelope where an address and postage would ordinarily be placed.

### CROSS-REFERENCE TO RELATED APPLICATIONS

This application incorporates provisional application No. 60/269,475 by this reference. Provisional application No. 60/269,475 was filed on Feb. 16, 2001. Applicant claims the benefit of the Feb. 16, 2002 filing date pursuant to 35 U.S.C. 119.

### STATEMENT AS TO RIGHTS TO INVENTIONS MADE UNDER FEDERALLY-SPONSORED RESEARCH DEVELOPMENT

This invention was not made under Federally sponsored research and development. All rights are retained by the inventor.

### BACKGROUND OF THE INVENTION

This invention is primarily conceived as a way that a performing artist can send out photos of him or herself in an envelope which will allow those photos to be seen even before the envelope is opened. Performing artists must disseminate photos of themselves, commonly called “headshots,” in order to get auditions and for other reasons related to promotion of the artist's services.

1. Field of the Invention

This invention falls within the field of envelopes for the mailing of correspondence. More specifically, it falls within the field of window envelopes for the mailing of correspondence in such a way that part of the contents can be viewed without opening the envelope.

2. Description of Related Art Including Information Disclosed Under 37 CFR Sections 1.97 and 1.98.

Envelopes in one form or another have been used for over two hundred years to send correspondence through the U. S. Mail. Window envelopes have been developed more recently, sometimes with a glassine or plastic covering on the window. These envelopes have been found useful for purposes of mass correspondence such as the mailing out of billing statements. A computer can print an address on a preset field of the correspondence and the address will appear in the window when the correspondence is folded and placed in the envelope. This makes it unnecessary to address the envelopes since the computer can easily be programmed to match the correct address with the correct billing information on the bill.

### SUMMARY OF THE INVENTION

This invention comprises an envelope which has a window suitably sized and positioned so that a performing artist can mail out a “headshot” to someone and the head shot can be seen even while the envelope is closed. In this way the artist will be promoted even to persons other than the addressee and the addressee will see the artist even if the envelope is not opened. This invention is further useful over a “headshot” made into the form of a post card, in that correspondence other than the head shot can be included in this envelope and still not be read without the envelope being opened.

### BRIEF DESCRIPTION OF THE DRAWINGS

FIG. 1 shows the front of the invention with the window through which a “headshot” could be seen.

FIG. 2 shows the back of the invention including the flap which would be used to seal the envelope closed.

### DESCRIPTION OF THE PREFERRED EMBODIMENT

This invention provides a window envelope that is specially constructed so that the window shows a promotional photograph of the sender when the envelope is still sealed. Unlike common window envelopes which are made for the purpose of showing the address printed on a computer generated form, this invention may have the address information placed on the opaque portion of the envelope. The purpose of the invention is instead to display a specific portion of the correspondence other than the destination address while the envelope is being mailed. The artist, or the artist's agent, can then mail a “headshot” along with any other correspondence that is being mailed and do so in such a way that the artist's look is being promoted at the same time. This helps the artist add value and marketability to his or her persona while at the same time ensuring that the public exposure generated by the mailing will take place even if the envelope is never opened.

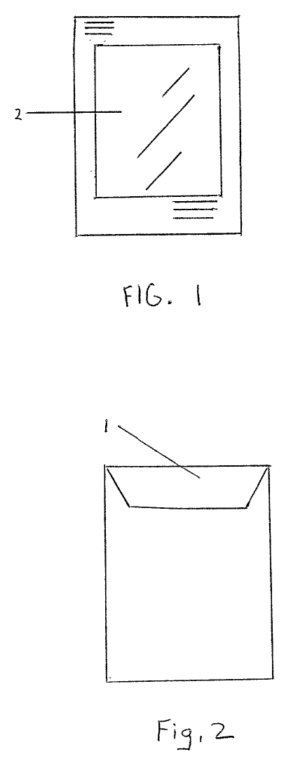

Like most envelopes, this envelope has a front and a back. The back of an envelope is commonly where the flap (1) that closes the envelope attaches to the envelope proper, thereby sealing the envelope. That is the case in this invention as well. The back of the envelope can be seen depicted at FIG. 2. Referring now to FIG. 1, which depicts the front of the envelope, to which the flap does not attach in its normal use, the invention can be seen to contain a transparent window (2) centered so that a “headshot” can show through. The width and length of the window are such that the face of the sender can clearly been seen on the “headshot” through the window. In the preferred embodiment, the dimensions would be about 7″ wide by 8.5″ tall, or thereabouts. Thus, on a 9″ by 12″ envelope, which experimentation suggests is the best size, there can be an opaque top margin of 1.5 inches, opaque side margins of 1 inch each, and an opaque bottom margin of 2 inches and a “headshot” would still be clearly visible through the envelope's window. The return address may be written on the upper left portion of the 1.5 inch top margin although it may be placed in other locations. Similarly, the destination address may be placed in the 2 inch lower margin, somewhat to the right of the return address, although the destination address could also be placed somewhere else. An alternative configuration would be to turn the envelope ¼ turn and place the return address in one of the 1 inch margins at the upper left of the envelope (as it then would appear) and place the destination address in the other 1 inch margin down below.

The standard form of this invention would be colored like other manila envelopes in the opaque regions, but the envelope could be also produced in various colors such as blue, pink, yellow, or grey. Such changes would not depart from the spirit of the invention as long as there is a transparent window in the front of the envelope through which the artist's “headshot” can be seen.

Other uses for this invention can be seen in that other photos can be sent along with accompanying private correspondence. If the sender wished to send an 8″ by 10″ winter scene as a greeting card but also wished to send a lengthy private letter, this invention would serve that purpose much better than an ordinary holiday greeting card, where space is limited.

I claim:

1. An envelope comprising a substantially planar quadrangular front having a first inside, a first outside, a first edge, a second edge, a third edge, a fourth edge, and a window communicating between said first inside and said first outside, said fourth edge having a flap foldably joined to said fourth edge; a substantially planar quadrangular back having a second inside, a second outside, a fifth edge, a sixth edge, a seventh edge, an eighth edge, said eighth edge being aligned coaxially with said fourth edge; said eighth edge not being joined to said fourth edge; said first edge being joined coextensively to said fifth edge; said second edge being joined coextensively to said sixth edge; said third edge being joined coextensively to said seventh edge; so that a pouch is formed between said front and said back with said first inside facing said second inside; said pouch having an opening between said fourth edge and said eighth edge.

2. The envelope of claim 1 in which said flap bears adhesive so that it can be folded over and attached to said second outside.

3. The envelope of claim 1 in which a transparent substantially planar sheet is attached to said first inside so that objects in said pouch cannot pass through said window.

4. An envelope comprising a planar rectangular front having a first inside, a first outside, a 30.48 centimeter long first edge, a 22.86 centimeter long second edge, a 30.48 centimeter long third edge, a 22.86 centimeter long fourth edge, and a window communicating between said first inside and said first outside; said window having a suitable area so that a photograph 20.32 centimeters by 25.4 centimeters can readily be viewed therethrough; a planar rectangular back having a second inside, a second outside, a 30.48 centimeter long fifth edge, a 22.86 centimeter long sixth edge, a 30.48 centimeter long seventh edge, a 22.86 centimeter long eighth edge, said eighth edge being aligned coaxially with said fourth edge, said seventh edge being aligned coaxially with said third edge, said sixth edge being aligned coaxially with said second edge, and said fifth edge being aligned coaxially with said first edge; three edges selected from the group consisting of said first edge, said second edge, said third edge, and said fourth edge each being coextensively attached to a coaxially aligned edge of said back so that a pouch is formed between said front and said back with said first inside facing said second inside.

5. The envelope of claim 4 in which said first edge is not attached to said fifth edge; said first edge having means for attachment to said fifth edge.

6. The envelope of claim 5 in which said means for attachment is a flap foldably attached to said first edge; said flap having adhesive situated so that said adhesive can be placed against said fifth edge to close said pouch.

7. The envelope of claim 4 in which said second edge is not attached to said sixth edge; said second edge having means for attachment to said sixth edge.

8. The envelope of claim 7 in which said means for attachment is a flap foldably attached to said second edge; said flap having adhesive situated so that said adhesive can be placed against said sixth edge to close said pouch.

9. The envelope of claim 4 further comprising a transparent substantially planar sheet attached to said first inside so that physical objects cannot pass through said window.
